(19) United States
(12) Patent Application Publication
(10) Pub. No.: US 2021/0004845 A1
(43) Pub. Date: Jan. 7, 2021

(54) METHOD OF PREDICTING DEMAND FOR NATURAL INGREDIENTS OF COSMETICS AND APPARATUS FOR PERFORMING THE SAME

(71) Applicant: Seong Jin NA, Gyonggi-do (KR)

(72) Inventor: Seong Jin NA, Gyonggi-do (KR)

(21) Appl. No.: 16/575,848

(22) Filed: Sep. 19, 2019

(30) Foreign Application Priority Data
Jul. 2, 2019 (KR) 10-2019-0079223

(51) Int. Cl. G06Q 30/02

(52) U.S. Cl. CPC G06Q 30/0202; G06Q 30/0201

(57) ABSTRACT

A method of predicting a demand for natural ingredients of cosmetics, the method including collecting, by a cosmetic production determining apparatus, usage-pattern-specific order information of a cosmetic and determining, by the cosmetic production determining apparatus, a time-point-specific demand for the cosmetic on the basis of the usage-pattern-specific order information.

### CROSS-REFERENCE TO RELATED APPLICATIONS

This application claims priority to Korean Patent Application No. 10-2019-0079223 filed on Jul. 2, 2019 in the Korean Intellectual Property Office (KIPO), the entire contents of which are hereby incorporated by reference.

### FIELD

The present invention relates to a method of predicting the demand for natural ingredients of cosmetics and an apparatus for performing the same, and more specifically, to a method of predicting the demand for natural ingredients of cosmetics capable of predicting the demand for cosmetics manufactured with natural ingredients provided from nature, and an apparatus for performing the same.

### BACKGROUND

Functional cosmetic ingredients refer to ingredients that implement specific functions for purposes of, for example, a product supporting skin brightening, a product supporting wrinkle improvement, a product supporting gentle tanning, or protection from ultraviolet radiation, and so on, that are contained in cosmetics placing an emphasis on a specific function than general cosmetics.

In Korea, cosmetics were regulated by the Pharmaceutical Affairs Act until 1998, but since July 2000, have been managed according to the Cosmetics Act, which was enacted in September 1999. On the basis of the Cosmetics Act, cosmetics are excluded from products corresponding to medicines according to Article 2 of the Pharmaceutical Affairs Act. Among cosmetics, a product supporting skin brightening, a product supporting wrinkle improvement, and a product supporting gentle tanning or protection from ultraviolet radiation are defined as functional cosmetics by law.

Currently, the categories of functional cosmetics are expanding with the growing natural cosmetics market combined with developing biotechnology. Until the mid-2000s, functional cosmetics using synthetic chemicals as ingredients were popular in the domestic functional cosmetics market, but currently, with the recent development of biotechnology, there is a growing interest in ingredients with a natural origin, which maintain the unique protection function and constancy of a human body against deterioration of natural environment and external harmful environment factors, as ingredients of functional cosmetics. Hydroquinone, a synthetic chemical that suppresses production of melanin, used as a main ingredient of whitening cosmetics, was designated as a carcinogen and thus is being replaced with natural materials, such as arbutin (cranberry tree extract), mulberry extract, and the like, showing a transition of main ingredients of major functional cosmetics into a natural extract or natural-origin component.

In order to produce cosmetics on the basis of natural extracts, it is crucial to predict the supply time and supply amount of natural materials and the demand for cosmetics and supply cosmetics. Disclosed is a method of accurately predicting the supply time and supply amount of natural materials and the demand for cosmetics and supplying cosmetics.

### SUMMARY

The present invention is directed to providing a method of predicting the demand for natural ingredients of cosmetics that is capable of accurately predicting the demand for cosmetics that use natural ingredients and supplying cosmetics, and an apparatus for performing the same.

The present invention is directed to providing a method of predicting the demand for natural ingredients of cosmetic that is capable of producing cosmetics at a point in time in which distribution of cosmetics is available while reducing the manufacturing cost by considering an expiration date for each cosmetic and a natural ingredient used for each cosmetic on the basis of the prediction of the demand for cosmetics using natural ingredients, and an apparatus for performing the same.

The technical objectives of the present invention are not limited to the above, and other objectives may become apparent to those of ordinary skill in the art based on the following descriptions.

Representative configurations of the present invention for achieving the objectives are as follows.

One aspect of the present invention provides a method of predicting a demand for natural ingredients of cosmetics, the method comprising collecting, by a cosmetic production determining apparatus, usage-pattern-specific order information of a cosmetic and determining, by the cosmetic production determining apparatus, a time-point-specific demand for the cosmetic on the basis of the usage-pattern-specific order information.

Also, wherein the usage-pattern-specific order information includes order information of each of a plurality of usage patterns and each of the plurality of usage patterns is a combination of a plurality of cosmetics according to an intended use.

Also, the time-point-specific demand for the cosmetic is determined on the basis of a previous usage-pattern-specific first order and a predicted usage-pattern-specific first order.

Also, the time-point-specific demand for the cosmetic is determined on the basis of a reorder prediction from the previous usage-pattern-specific first order and a reorder prediction from the predicted usage-pattern-specific first order.

Another aspect of the present invention provides a cosmetic production determining apparatus for predicting a demand for cosmetics using natural ingredients, the cosmetic production determining apparatus comprising a processor, wherein the processor is configured to collect usage-pattern-specific order information of a cosmetic and determine a time-point-specific demand for the cosmetic on the basis of the usage-pattern-specific order information.

Also, the usage-pattern-specific order information includes order information of each of a plurality of usage patterns, and each of the plurality of usage patterns is a combination of a plurality of cosmetics according to an intended use.

Also, the time-point-specific demand for the cosmetic is determined on the basis of a previous usage-pattern-specific first order and a predicted usage-pattern-specific first order.

Also, the time-point-specific demand for the cosmetic is determined on the basis of a reorder prediction from the previous usage-pattern-specific first order and a reorder prediction from the predicted usage-pattern-specific first order.

### BRIEF DESCRIPTION OF DRAWINGS

Example embodiments of the present invention will become more apparent by describing example embodiments of the present invention in detail with reference to the accompanying drawings, in which:

FIG. 1 is a conceptual diagram illustrating a cosmetic production determining apparatus for predicting the demand for cosmetics using natural ingredients and producing the cosmetics according to an embodiment of the present invention;

FIG. 2 is a conceptual diagram illustrating an operation of predicting the demand for a cosmetic by the cosmetic demand predicting unit;

FIG. 3 is a conceptual diagram illustrating a method of determining the time-point-specific demand for a cosmetic according to an embodiment of the present invention;

FIG. 4 is a conceptual diagram illustrating a method of predicting a demand for a cosmetic according to an embodiment of the present invention;

FIG. 5 is a conceptual diagram illustrating a method of predicting the demand for a cosmetic according to an embodiment of the present invention; and

FIG. 6 is a conceptual diagram illustrating a method of predicting the demand for a cosmetic according to an embodiment of the present invention.

### DETAILED DESCRIPTION

In the following detailed description of the present inventive concept, references are made to the accompanying drawings that show, by way of illustration, specific embodiments in which the present inventive concept may be practiced. These embodiments are described in sufficient detail to enable those skilled in the art to practice the present inventive concept. It is to be understood that the various embodiments of the present inventive concept, although different from each other, are not necessarily mutually exclusive. For example, specific shapes, structures and characteristics described herein may be implemented as modified from one embodiment to another without departing from the spirit and scope of the present inventive concept. Furthermore, it shall be understood that the locations or arrangements of individual components within each embodiment may also be modified without departing from the spirit and scope of the present inventive concept. Therefore, the following detailed description is not to be taken in a limiting sense, and the scope of the present inventive concept is to be taken as encompassing the scope of the appended claims and all equivalents thereof. In the drawings, like reference numerals refer to the same or similar elements throughout the several views.

Hereinafter, preferred embodiments of the present inventive concept will be described in detail with reference to the accompanying drawings to enable those skilled in the art to easily implement the present inventive concept.

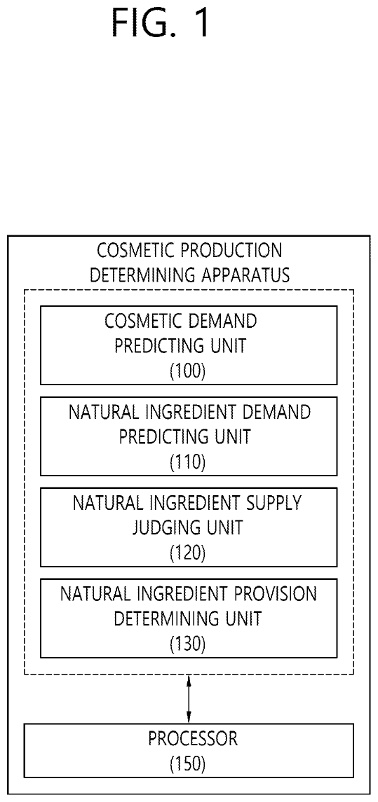

FIG. 1 is a conceptual diagram illustrating a cosmetic production determining apparatus for predicting the demand for cosmetics using natural ingredients and producing the cosmetics according to an embodiment of the present invention.

FIG. 1 discloses a cosmetic production determining apparatus for determining a time-point-specific natural ingredient demand for each of one or more natural ingredients used for each of a plurality of cosmetics by considering a time-point-specific cosmetic demand for each of the plurality of cosmetics, and effectively providing natural ingredients.

Referring to FIG. 1, the cosmetic production determining apparatus may include a cosmetic demand predicting unit 100, a natural ingredient demand predicting unit 110, a natural ingredient supply judging unit 120, a natural ingredient provision determining unit 130, and a processor 150.

The cosmetic demand predicting unit 100 may be implemented to predict the demand for cosmetics being sold. The cosmetic demand predicting unit 100 may predict a time-point-specific cosmetic demand that represents the demand for each of a plurality of cosmetics being sold at each point in time. Various types of cosmetics using various natural ingredients may be produced, and the time-point-specific cosmetic demand for each of the plurality of cosmetics according to the intended use and function thereof may be predicted.

The natural ingredient demand predicting unit 110 may be implemented to predict the demands for natural ingredients used in a plurality of cosmetics by considering the time-point-specific cosmetic demand for each of the plurality of cosmetics. In order to manufacture cosmetics, natural ingredients need to be supplied, and the demands for natural ingredients used in the plurality of cosmetics may be predicted on the basis of the time-point-specific cosmetic demand for each of the plurality of cosmetics. One or more natural ingredients used for each of the plurality of cosmetics may be different from each other or the same as each other. Accordingly, the natural ingredient demand predicting unit 110 may predict the demand for each of the one or more natural ingredients used in each of the plurality of cosmetics by considering the time-point-specific cosmetic demand for each of the plurality of cosmetics.

The natural ingredient supply judging unit 120 may be implemented to judge the supply amount of natural ingredients. When natural ingredients are used, the supply amount of each natural ingredient with time may be judged according to the harvest time of the natural ingredient and the distribution of supply sources of the natural ingredient. Since natural ingredients are extracted from natural materials, such as flowers, bark, and fruits, it is difficult to artificially control the time and supply amount of each natural ingredient. Accordingly, the natural ingredient supply judging unit 120 may be implemented to judge a time-point-specific natural ingredient supply for each natural ingredient.

The natural ingredient provision determining unit 130 may be implemented to determine provision of natural ingredients. The natural ingredient provision determining unit 130 may determine a provision capability index of a natural ingredient on the basis of the time-point-specific natural ingredient supply determined by the natural ingredient supply judging unit 120 and the time-point-specific natural ingredient demand determined by the natural ingredient demand predicting unit 110. The provision capability index of the natural ingredient is a value determined on the basis of the time-point-specific natural ingredient supply and the time-point-specific natural ingredient demand and is an index for determining whether supply of a natural ingredient is performable at a time when the natural ingredient is required. Details of the provision capability index of the natural ingredient will be described below.

In addition, the natural ingredient provision determining unit 130 may determine whether there is a need for an additional supply for each natural ingredient on the basis of the provision capability index of the natural ingredient, and with respect to a natural ingredient determined to require an additional supply, may determine an alternative natural ingredient and an alternative supply source and provide the alternative natural ingredient and the alternative supply source as determined.

The processor 150 may be implemented to control operations of the cosmetic demand predicting unit 100, the natural ingredient demand predicting unit 110, the natural ingredient supply judging unit 120, and the natural ingredient provision determining unit 130.

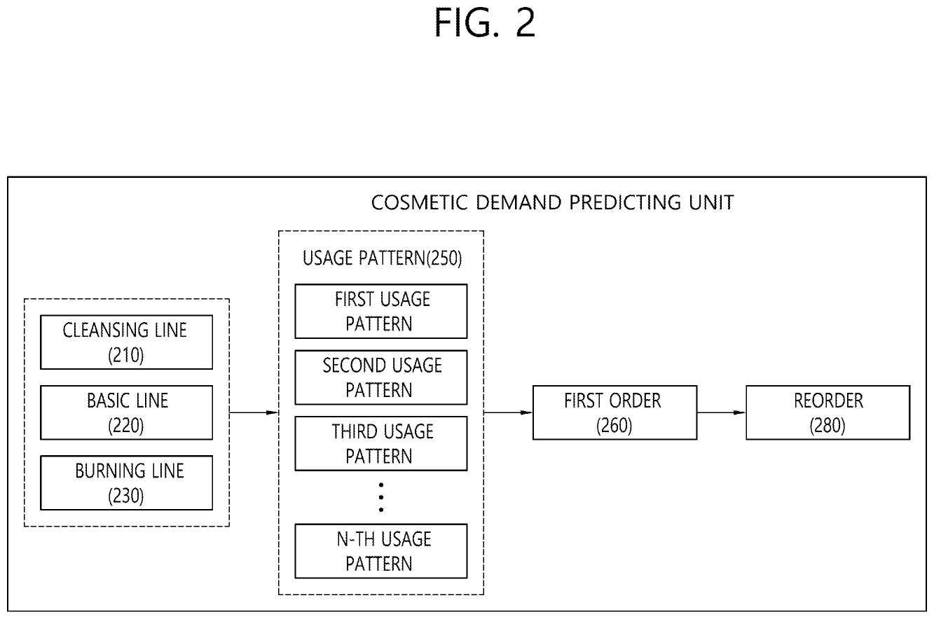

FIG. 2 is a conceptual diagram illustrating an operation of predicting the demand for a cosmetic by the cosmetic demand predicting unit.

FIG. 2 discloses a method of predicting the demand for a cosmetic by the cosmetic demand predicting unit.

Referring to FIG. 2, the cosmetic demand predicting unit may predict the demand for a cosmetic on the basis of a cosmetic purchase and usage pattern of a customer.

The cosmetics according to the embodiment of the present invention may include cosmetics of a cleansing line 210, a basic line 220, and a burning line 230, and the usage combination of the cleansing line 210, the basic line 220, and the burning line 230 may vary depending on the purpose of a customer using the cosmetics. The cleansing line 210 is a product line for cleansing and may include a foam cleanser product. The basic line 220 may include basic skin care products, such as a toner or lotion function product, and a protecting product for skin protection. The burning line 230 may include a functional enhancement skin care product in which a particular function, such as wrinkle improvement and whitening is enhanced. Such cosmetic lines are arbitrarily named and may be assigned with various names.

The basic line 220 and the burning line 230 may each include a plurality of products, and a consumer may use a different combination of the basic lines and the burning lines according to the intended use. A usage pattern 250 of using a cosmetic by a consumer may be classified into a plurality of patterns shown below. Assuming that the basic line 220 includes five types of products and the burning line 230 includes two types of products, the usage pattern 250 may be classified into a first usage pattern (five types of cosmetics of the basic line), a second usage pattern (two types of cosmetics of the burning line), a third usage pattern (five types of cosmetics of the basic line+one type of a cosmetic of the burning line), a fourth usage pattern (five types of cosmetics of the basic line+two types of cosmetics of the burning line), a fifth usage pattern (four types of cosmetics of the basic line including a protector+one type of a cosmetic of the burning line), a sixth usage pattern (four types of cosmetics of the basic line excluding a protector+two types of cosmetics of the burning line), a seventh usage pattern (three types of cosmetics of the basic line+one type of a cosmetic of the burning line), and an eighth usage pattern (three types of cosmetics of the basic line+two types of cosmetics of the burning line).

According to the embodiment of the present invention, the usage patterns 250 of the products are collected, and the amount of demand for each usage pattern 250 is predicted to predict the amount of demand of each cosmetic included in the usage pattern 250.

According to the embodiment of the present invention, the amounts of usage of cosmetics contained in the usage pattern 250 may be predicted for each usage pattern 250 and may be predicted by considering cosmetics sequentially ordered after the first order and a usage pattern change.

Specifically, assuming one user, the user may order five types of cosmetics of the basic line included in the first usage pattern all at once in a first order 260. The volumes of cosmetics included in the five types of cosmetics of the basic line are different from each other, and the points of time of the reorder (a second order, a third order, and the like) of the respective five types of cosmetics included in the basic line may be different from each other. For example, it may be assumed that five types of cosmetics of the basic line include a cosmetic (basic line-1), a cosmetic (basic line-2), a cosmetic (basic line-3), a cosmetic (basic line-4), and a cosmetic (basic line-5). When the first usage pattern is used, the cosmetic (basic line 3), the cosmetic (basic line-2), the cosmetic (basic line-1), the cosmetic (basic line-4), and the cosmetic (basic line-5) may be sequentially consumed according to the total volume and the application area of the cosmetic.

After the first order 260, a second order corresponding to a reorder 280 may be performed in the sequence of the cosmetic (basic line-3), the cosmetic (basic line-2), the cosmetic (basic line-1), the cosmetic (basic line-4), and the cosmetic (basic line-5). The point in time of the second order of each of the cosmetic (basic line-3), the cosmetic (basic line-2), the cosmetic (basic line-1), the cosmetic (basic line-4), and the cosmetic (basic line-5) may be individually determined by considering the volume of the cosmetic, the amount of the cosmetic used per day, the application area of the cosmetic, and the like.

A method of determining a time-point-specific cosmetic demand considering the usage pattern 250 of the user, the first order 260, and the reorder 280 (the second order, the third order, and the like) will be described below.

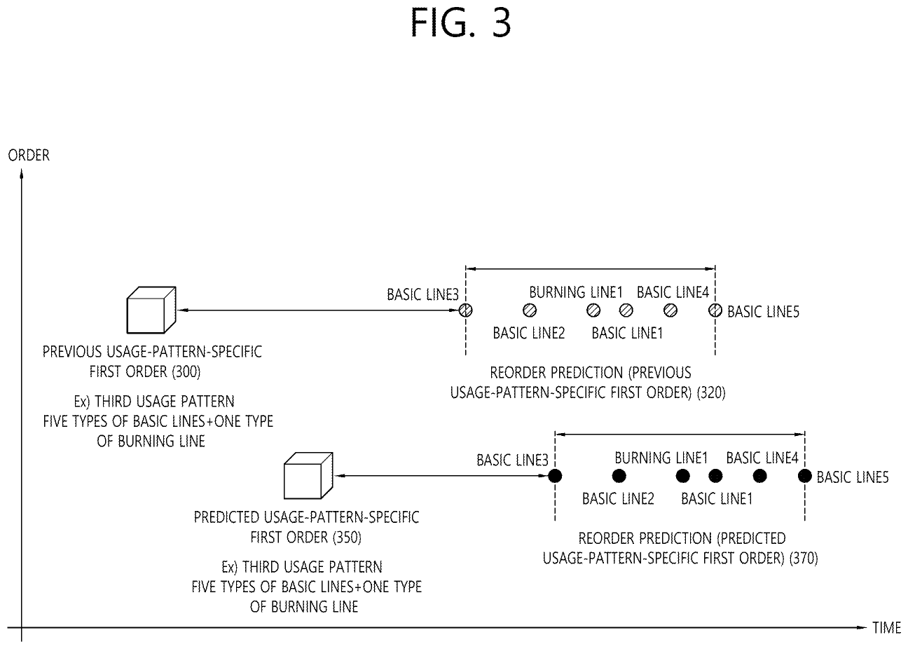

FIG. 3 is a conceptual diagram illustrating a method of determining the time-point-specific demand for a cosmetic according to an embodiment of the present invention.

FIG. 3 discloses a method of determining a time-point-specific cosmetic demand using a usage pattern of a user, a first order, and a reorder.

Referring to FIG. 3, as a first prediction, a user-specific usage pattern may be predicted such that a time-point-specific cosmetic demand may be determined. The criterion for the first prediction may be the first order, including a previous usage-pattern-specific first order 300 and a predicted usage-pattern-specific first order 350.

Once first orders are placed for each of the first to eighth usage patterns, a previous usage-pattern-specific first order 300 is determined, and a first order quantity is predicted on the basis of the previous usage-pattern-specific first order 300 so that a predicted usage-pattern-specific first order 350 is generated. In consideration of the previous monthly order quantity and the previous monthly order increase and decrease trends, first orders for the first to eighth usage patterns may be predicted. Specifically, a first order quantity for a certain usage pattern may be predicted by considering the monthly first order increase trend and the monthly first order decrease trend. In this case, a monthly first order increase rate, a monthly first order decrease rate, the maximum value of an order quantity increase, and the maximum value of an order quantity decrease may be determined by considering the maximum value of the previous order quantity and the minimum value of the previous order quantity.

With the above described method, information about the previous usage-pattern-specific first order 300 for each of the first to eighth usage patterns and information about the predicted usage-pattern-specific first order 350 for each of the first to eighth usage patterns may be generated.

Thereafter, as a second prediction, a reorder prediction based on the previous usage-pattern-specific first order and a reorder prediction based on the predicted usage-pattern-specific first order may be performed. The reorder prediction based on the previous usage-pattern-specific first order may be represented as a reorder prediction (the previous usage-pattern-specific first order) 320, and the reorder prediction based on the predicted usage-pattern-specific first order may be represented as a reorder prediction (the predicted usage-pattern-specific first order) 370.

The reorder prediction (the previous usage-pattern-specific first order) 320 and the reorder prediction (the predicted usage-pattern-specific first order) 370 may be performed by considering the point in time at which a certain cosmetic for each usage pattern is reordered. For example, when the third usage pattern (five types of cosmetics of the basic line+one type of a cosmetic of the burning line) is used, the five types of cosmetics of the basic line and the one type of a cosmetic of the burning line are put in the first order, and a reorder pattern is formed according to particular points of time by a pattern in which the cosmetics are consumed (for example, in the order of a cosmetic (basic line-3), a cosmetic (basic line-2, a cosmetic (burning line-1), a cosmetic (basic line-1), a cosmetic (basic line-4), and a cosmetic (basic line-5)), and a reorder is performed. Such a usage-pattern-specific reorder pattern may be determined on the basis of a prediction on the amount of usage of a cosmetic and a previous usage-pattern-specific reorder.

A time-point-specific order pattern is predicted for each of the reorder prediction (the previous usage-pattern-specific first order) 320 and the reorder prediction (the predicted usage-pattern-specific first order) 370 such that the second prediction may be performed.

In addition, according to the embodiment of the present invention, the performance of the reorder prediction (the previous usage-pattern-specific first order) 320 and the reorder prediction (the predicted usage-pattern-specific first order) 370 in the second prediction may further include considering a change in usage pattern for each of the first to eighth usage patterns. For example, when considering information about a change in usage patterns of the existing consumers, a probability that a change is made from the first usage pattern to one of the second to sixth usage patterns exists, and according to such a change in usage pattern, cosmetics reordered after the first order may vary.

According to the embodiment of the present invention, the time-point-specific cosmetic demand may be predicted on the basis of the first prediction and the second prediction (or the second prediction that considers a probabilistic change in usage pattern). The point in time of a cosmetic supply based on such a cosmetic demand may be determined on the basis of clustering.

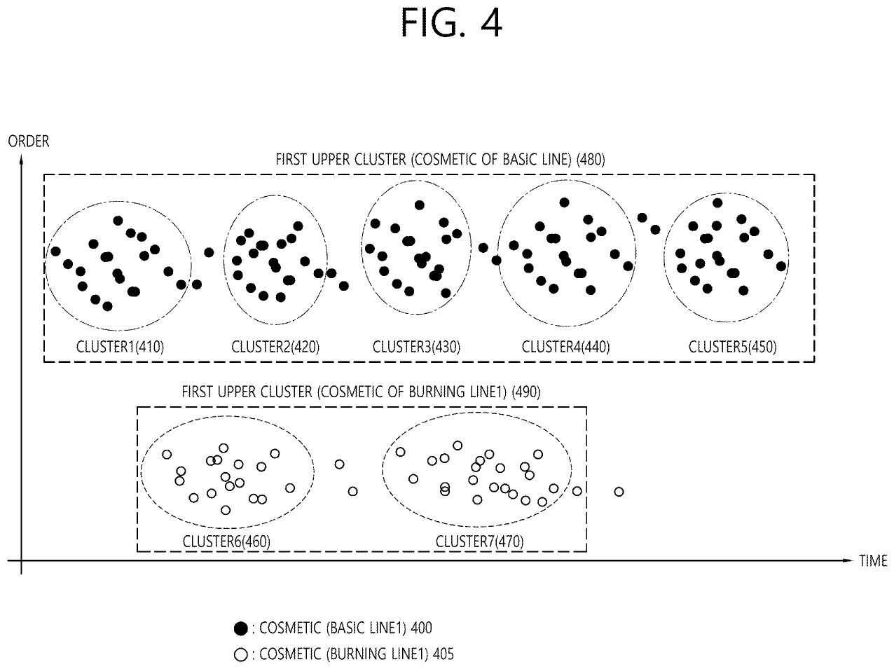

FIG. 4 is a conceptual diagram illustrating a method of predicting a demand for a cosmetic according to an embodiment of the present invention.

FIG. 4 discloses a method of predicting the demand for a cosmetic in units of adaptive time sections by performing clustering according to cosmetics on the basis of the time-point-specific cosmetic information determined in FIG. 3.

Referring to FIG. 4, the graph of FIG. 4 may include information about the amount of demand of each cosmetic in an absolute time unit expressed on the time axis thereof. However, producing as much of the cosmetics as possible all at once considering the expiration date may be economical and enhance the production efficiency. Accordingly, the amount of production (supply) of cosmetics to be produced (supplied) at a particular point in time may be determined on the basis of clustering on each cosmetic.

When the clustering is performed on each cosmetic, the clustering may be performed on the basis of a point in time that requires a great volume of production for each cosmetic, and at least one cluster may be formed with respect to a single cosmetic.

For example, on the time axis, five clusters 410, 420, 430, 440, and 450 may be formed with respect to cosmetics (basic line-1) 400, and two clusters 460 and 470 may be formed with respect to cosmetics (burning line-1) 405. In this case, the five clusters 410, 420, 430, 440, and 450 (a first cluster to a fifth cluster) with respect to the cosmetics (basic line-1) 400 may be aggregated to form a first upper cluster (the cosmetic of the basic line) 480. In addition, the cosmetics (burning line-1) 405 may be aggregated on the basis of the two clusters 460 and 470 (a six cluster and a seventh cluster) with respect to the cosmetics (burning line-1) 405 to form a first upper cluster (the cosmetic of the burning line) 490.

Specifically, the production of the cosmetic (basic line-1) may be performed by setting the first to third clusters as one production unit and setting the fourth and fifth clusters as another one production unit by considering the expiration date for the cosmetic (basic line-1). With respect to an expiration date, a set of at least one cluster included in a threshold distribution period considering the expiration date may be set as the first upper cluster. The threshold distribution period may be a value obtained by multiplying the expiration date by a first inventory available index for each cosmetic. The inventory available index may be a value determined by considering the producer price of each cosmetic and a loss when the cosmetic is not sold.

In this way, the production for each cosmetic may be determined on the basis of an upper cluster including at least one cluster associated with a cosmetic determined by considering a threshold distribution period of the cosmetic and may be set to be performed in an adaptive time period by considering the demand for the cosmetic.

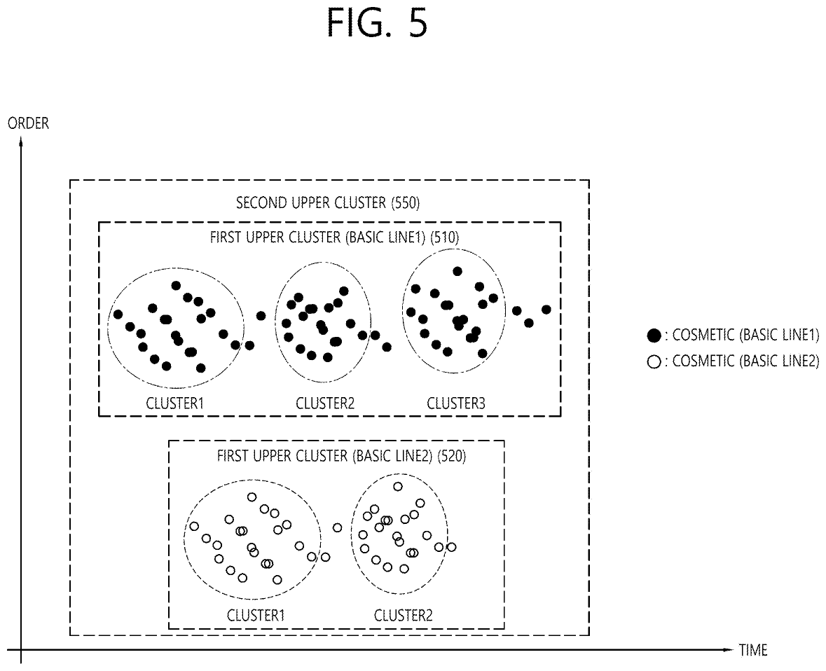

FIG. 5 is a conceptual diagram illustrating a method of predicting the demand for a cosmetic according to an embodiment of the present invention.

FIG. 5 discloses a clustering method for determining cosmetic production for prediction of cosmetic demand.

Referring to FIG. 5, a method of forming a second upper cluster for determining the production of cosmetics after the clustering for predicting the demand for cosmetics is disclosed. The second upper cluster may be a set including first upper clusters having different cosmetics.

Specifically, a first upper cluster (basic line-1) 510 of cosmetics (basic line-1) and a first upper cluster (basic line-2) 520 of cosmetics (basic line-2) may be combined to form a second upper cluster 550.

The second upper cluster 550 may be formed by combining the first upper clusters 510 and 520, each of which includes a plurality of cosmetics produced with similar manufacturing processes and composed of similar components between the respective first upper clusters 510 and 520. When the manufacturing processes are similar and the components are similar, batch production is beneficial in lowering the production cost. Accordingly, the second upper cluster 550 may be formed with respect to cosmetics in which a manufacturing similarity and a component similarity exceed a threshold similarity value by considering manufacturing similarities and component similarities of the respective cosmetics.

Similarly, with respect to an expiration date, the second upper cluster 550 may be formed by a set of one of more first upper clusters 510 and 520 included in a threshold distribution period considering the expiration date. The threshold distribution period may be a value obtained by multiplying the expiration date by a second inventory available index for each cosmetic. The second inventory available index may be a value determined by considering the producer prices of a plurality of cosmetics included in the second upper cluster 550 and a loss when the plurality of cosmetics included in the second upper cluster 550 are not sold.

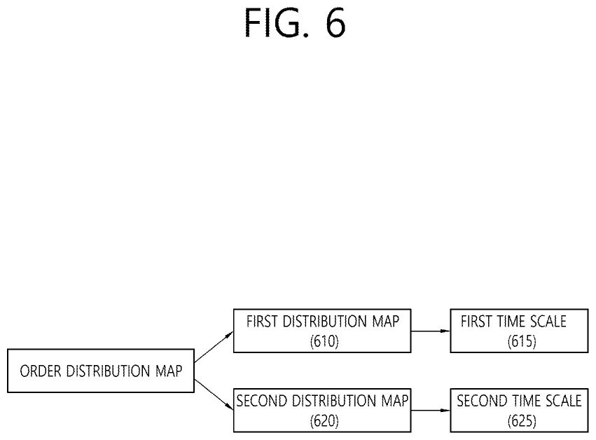

FIG. 6 is a conceptual diagram illustrating a method of predicting the demand for a cosmetic according to an embodiment of the present invention.

FIG. 6 discloses a clustering method for determining cosmetic production for prediction of cosmetic demand.

Referring to FIG. 6, a method of performing clustering by adjusting a prediction scale for each cosmetic is disclosed.

When clustering is performed on the basis of the distribution of orders of individual cosmetics, the clustering may be performed by performing scaling on the time axis. For example, when an order distribution map based on the distribution of orders of cosmetics has a first distribution map 610, the time axis may be set to a first time scale 615 such that order information of the cosmetics is expressed on the first time scale 615, and the clustering may be performed on the first time scale 615. Similarly, when an order distribution map based on the distribution of orders of cosmetics has a second distribution map 620, the time axis may be set to a second time scale 625 such that order information of the cosmetics is expressed on the second time scale 625, and the clustering may be performed on the second time scale 625.

When the distribution of cosmetic order information is broad and thus the distribution map is large, the time scale may be increased. On the other hand, when the distribution of cosmetic order information is narrow and thus the distribution map is small, the time scale may be decreased.

With the method above, clustering operations may be performed on different time scales, and the clustering results on a plurality of cosmetics may be expressed on the same time scale. In this way, clustering may be more rapidly performed, and the clustering result is provided with an enhanced tendency on cosmetics ordered.

The above-described embodiments of the present invention may be implemented in the form of program instructions executable by various computer elements and recorded in a computer-readable recording medium. The computer-readable recording medium may include program instructions, data files, data structures, etc. alone or in combination. The program instructions recorded on the computer-readable recording medium may be specially designed and configured for the present invention or known to and used by those of ordinary skill in the computer software field. Examples of the computer-readable recording medium include magnetic media, such as a hard disk, a floppy disk, and magnetic tape, optical media, such as a compact disc read-only memory (CD-ROM) and a digital versatile disc (DVD), magneto-optical media, such as a floptical disk, and hardware devices, such as a ROM, a random access memory (RAM), and a flash memory, specially configured to store and perform program instructions. Examples of the program instructions include not only machine language code produced by a compiler but also high-level language code that can be executed by a computer through an interpreter or the like. To perform the operations of the present invention, the hardware devices may be configured as one or more software modules, and vice versa.

While the present invention has been described above with reference to specific details, such as detailed elements, by way of limited embodiments and drawings, these are provided merely to aid the overall understanding of the present invention. The present invention is not limited to the embodiments, and various modifications and changes can be made thereto by those of ordinary skill in the technical field to which the present invention pertains.

Therefore, the spirit of the present invention should not be limited to the above-described embodiments, and the scope of the present invention should be regarded as encompassing not only the following claims but also their equivalents and variations.

What is claimed is:

1. A method of predicting a demand for natural ingredients of cosmetics, the method comprising:
collecting, by a cosmetic production determining apparatus, usage-pattern-specific order information of a cosmetic; and
determining, by the cosmetic production determining apparatus, a time-point-specific demand for the cosmetic on the basis of the usage-pattern-specific order information.

2. The method of claim 1, wherein the usage-pattern-specific order information includes order information of each of a plurality of usage patterns, and
each of the plurality of usage patterns is a combination of a plurality of cosmetics according to an intended use.

3. The method of claim 2, wherein the time-point-specific demand for the cosmetic is determined on the basis of a previous usage-pattern-specific first order and a predicted usage-pattern-specific first order.

4. The method of claim 3, wherein the time-point-specific demand for the cosmetic is determined on the basis of a reorder prediction from the previous usage-pattern-specific first order and a reorder prediction from the predicted usage-pattern-specific first order.

5. A cosmetic production determining apparatus for predicting a demand for cosmetics using natural ingredients, the cosmetic production determining apparatus comprising:
a processor,
wherein the processor is configured to collect usage-pattern-specific order information of a cosmetic and determine a time-point-specific demand for the cosmetic on the basis of the usage-pattern-specific order information.

6. The cosmetic production determining apparatus of claim 5, wherein the usage-pattern-specific order information includes order information of each of a plurality of usage patterns, and
each of the plurality of usage patterns is a combination of a plurality of cosmetics according to an intended use.

7. The cosmetic production determining apparatus of claim 6, wherein the time-point-specific demand for the cosmetic is determined on the basis of a previous usage-pattern-specific first order and a predicted usage-pattern-specific first order.

8. The cosmetic production determining apparatus of claim 7, wherein the time-point-specific demand for the cosmetic is determined on the basis of a reorder prediction from the previous usage-pattern-specific first order and a reorder prediction from the predicted usage-pattern-specific first order.
